(19) United States
(12) Patent Application Publication
(10) Pub. No.: US 2021/0214102 A1
(43) Pub. Date: Jul. 15, 2021

(54) BASE STATION AND UNMANNED AERIAL VEHICLE CONTROL METHOD, AND UNMANNED AERIAL VEHICLE SYSTEM

(71) Applicant: SZ DJI TECHNOLOGY CO., LTD., Shenzhen (CN)

(72) Inventors: Qiang GENG, Shenzhen (CN); Peng WANG, Shenzhen (CN)

(21) Appl. No.: 17/195,621

(22) Filed: Mar. 8, 2021

Related U.S. Application Data
(63) Continuation of application No. PCT/CN2018/105186, filed on Sep. 12, 2018.

(51) Int. Cl. B64F 1/22; B64C 39/02; G08C 17/02; G08G 5/00

(52) U.S. Cl. CPC B64F 1/22; B64C 39/024; G05D 1/101; G08G 5/0069; B64C 2201/00; G08C 17/02

(57) ABSTRACT

The present disclosure provides a method for controlling a base station. The method includes establishing a wireless communication with an unmanned aerial vehicle (UAV), determining that the UAV has landed in a first area of the base station, controlling a first power device of the base station to move in a first direction to control a guiding mechanism of the base station to move toward a transferring device of the base station to push the UAV onto the transferring device, and controlling a second power device to move in a second direction to control a movement of the transferring device to transport the UAV to an operating platform.

### CROSS-REFERENCE TO RELATED APPLICATION

This application is a continuation of International Application No. PCT/CN2018/105186, filed on Sep. 12, 2018, the entire content of which is incorporated herein by reference.

### TECHNICAL FIELD

The present disclosure relates to the technical field of unmanned aerial vehicle (UAV) management and, more specifically, to a base station and UAV control method and a UAV system.

### BACKGROUND

The applications of UAVs have become more and more popular. UAVs are often more frequently used in areas with no people, in wilderness and across farmland or forest. The use of UAVs in these areas generally requires power source replacement, component maintenance, payload supplementation, and data exchange through the base station. The conventional base station operation method needs human intervention. For example, the UAV controller may need to control the UAV to accurately land on the base station and adjust the position of the UAV to wait for further operation, or manually operate the UAV in the base station, or control the UAV to take off after the UAV operation is completed. These conventional workflows are inefficient. In addition, when the number of UAVs is large, this problem is particular prominent. Thus, the conventional operation method can no longer meet the UAV operational demand. The conventional operation method cannot ensure that the UAV is accurately placed on the base station, or that the UAV is accurately placed on the operation station of the base station, and thus cannot ensure the operation safety of the UAV.

### SUMMARY

One aspect of the present disclosure provides a method for controlling a base station. The method includes establishing a wireless communication with an unmanned aerial vehicle (UAV); determining that the UAV has landed in a first area of the base station; controlling a first power device of the base station to move in a first direction to control a guiding mechanism of the base station to move toward a transferring device of the base station to push the UAV onto the transferring device; and controlling a second power device to move in a second direction to control a movement of the transferring device to transport the UAV to an operating platform.

Another aspect of the present disclosure provides a base station. The base station includes a processor, and a memory storing program instructions that, when being executed by the processor, cause the processor to: establish a wireless communication with a UAV; determine the UAV has landed in a first area of the base station; control a first power device of the base station to move in a first direction to control a guiding mechanism of the base station to move toward a transferring device push the UAV onto the transferring device; and control a second power device to move in a second direction to control a movement of the transferring device to transport the UAV to an operating platform.

Another aspect of the present disclosure provides a UAV control method. The UAV control method includes establishing a wireless communication with a base station; detecting whether the UAV meets a first predetermined strategy, and if so, sending a landing request to the base station; receiving a landing permission signal returned by the base station in response to the landing request; controlling the UAV to land in a first area of the base station to trigger the base station to perform an operation for transporting the UAV to an operating platform. The operating platform is configured to perform one or more operations of updating a power source of the UAV, replacing parts of the UAV, supplementing a payload of the UAV, or performing data exchange with the UAV.

Another aspect of the present disclosure provides a UAV configured to cooperate with a base station. The UAV includes a processor; and a memory storing program instructions that, when being executed by the processor, cause the processor to: establish a wireless communication with the base station; detect whether the UAV meets a first predetermined strategy, and if so, send a landing request to the base station; receive a landing permission signal returned by the base station in response to the landing request; and control the UAV to land in a first area of the base station to trigger the base station to perform an operation for transporting the UAV to an operating platform.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a structural block diagram of a UAV system according to an embodiment of the present disclosure.

FIG. 2 is a schematic diagram of a cooperation between a UAV and a base station according to an embodiment of the present disclosure.

FIG. 3 is a schematic structural diagram of a base station according to an embodiment of the present disclosure.

FIG. 4 is a schematic structural diagram of the base station in another state according to an embodiment of the present disclosure.

FIG. 5 is a structural block diagram of the base station according to an embodiment of the present disclosure.

FIG. 6 is a specific structural diagram of the base station according to an embodiment of the present disclosure.

FIG. 7 is a schematic structural diagram of the base station according to another embodiment of the present disclosure.

FIG. 8 is a structural block diagram of the base station according to another embodiment of the present disclosure.

FIG. 9 is a schematic structural block diagram of the base station according to another embodiment of the present disclosure.

FIG. 10 is a flowchart of a method for controlling a base station according to an embodiment of the present disclosure.

FIG. 11 is a flowchart of a method for controlling a UAV according to an embodiment of the present disclosure.

FIG. 12 is a structural block diagram of the base station according to an embodiment of the present disclosure.

FIG. 13 is a structural block diagram of the UAV according to an embodiment of the present disclosure.

FIG. 14 is a working flowchart of the UAV system according to an embodiment of the present disclosure.

### REFERENCE NUMERALS

| | |
|---|---|
| 100 | Base station |
| 101 | First processor |
| 102 | First storage device |
| 110 | First area |
| 120 | Transferring device |
| 130 | Guiding mechanism |
| 140 | First power device |
| 141 | Power component |
| 142 | Steel wire rope |
| 150 | Second power device |
| 160 | Operating platform |
| 170 | Sliding rail |
| 180 | First guiding part |
| 190 | Second area |
| 1100 | Transporting mechanism |
| 1200 | Third power device |
| 1300 | Second guiding part |
| 200 | UAV |
| 201 | Second processor |
| 202 | Second storage device |

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

The base station and vehicle of the present disclosure will be described with reference to the accompanying drawings. In the case where there is no conflict between the exemplary embodiments, the features of the following embodiments and examples may be combined with each other.

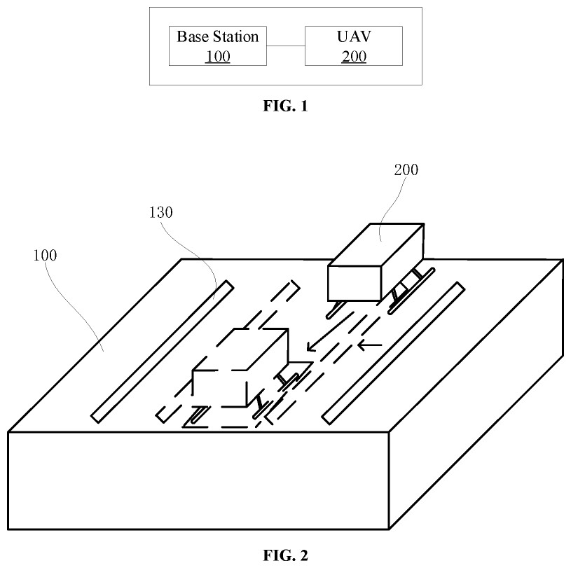

In the embodiments of the present disclosure, with reference to FIG. 1 and FIG. 2, the UAV system includes a base station 100 and a UAV 200, where the base station 100 and the UAV 200 can cooperate.

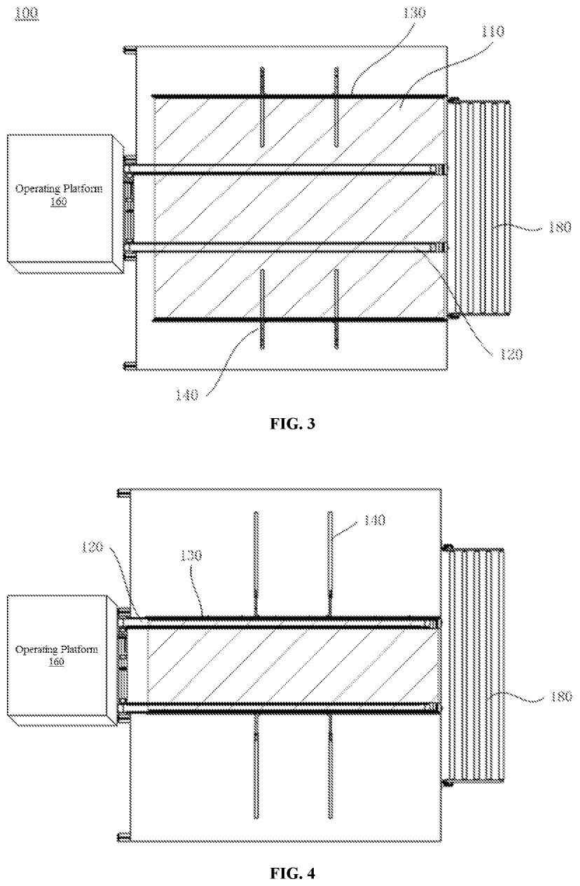

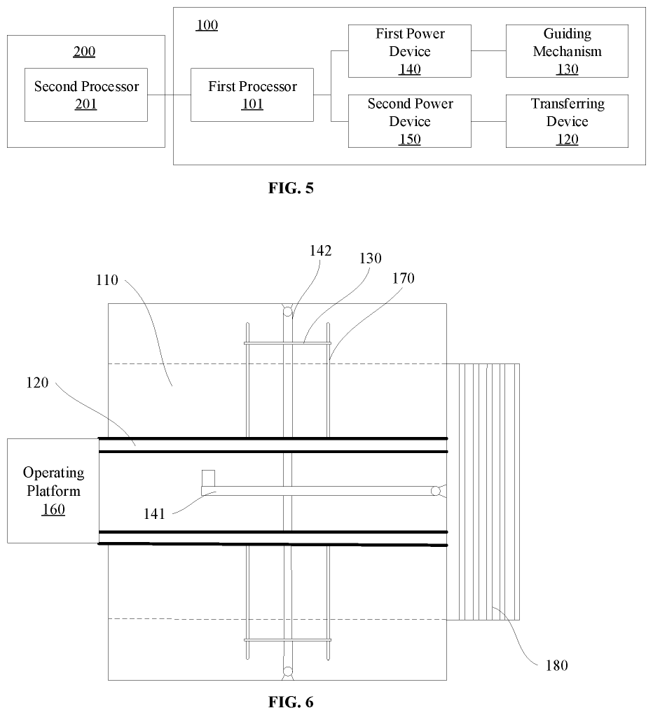

Referring to FIG. 3 to FIG. 5, the base station 100 includes a first area 110, a transferring device 120, a guiding mechanism 130, a first power device 140, and an operating platform 160. In some embodiments, the transferring device 120 may be disposed in the first area 110, the guiding mechanism 130 may be movably disposed relative to the transferring device 120, and the operating platform 160 may be adjacent to one end of the transferring device 120. In this embodiment, the first power device 140 can be used to drive the guiding mechanism 130 to move, and the guiding mechanism 130 can cooperate with the UAV 200 to push the UAV 200 to the transferring device 120. A second power device 150 can be used to drive the transferring device 120 to move, and transfer the UAV 200 on the transferring device 120 to the operating platform 160, and then the operating platform 160 can further operate the UAV 200. Further, the base station 100 can include a first processor 101. The first processor 101 can be electrically connected to the first power device 140 and the second power device 150, respectively. The first processor 101 can be configured to control the movement of the first power device 140 and the second power device 150.

The UAV 200 includes a second processor 201, and the first processor 101 can establish a communication connection with the second processor 201, thereby realizing the interaction between the UAV 200 and the base station 100. The UAV 200 of this embodiment may include at least one of a plant protection UAV (used to sow deeds, spray pesticides, water, etc.), a logistics UAV (used to transport goods, perform delivery, etc.), and an industry application UAV (for energy inspection, infrastructure exploration, building surveying and mapping, etc.), and an aerial photography UAV.

In this embodiment, the transferring device 120 may be positioned in the middle area of the first area 110, or it may be positioned in other positions of the base station 100. With the structural design of this embodiment, the UAV 200 can land on the first area 110, and then the UAV 200 can be pushed to the transferring device 120 through the guiding mechanism 130 without precisely controlling UAV 200 to land on the transferring device 120, and the control process of this embodiment is simple and easy to implement.

The structure of the transferring device 120 can be designed based on various requirements. The transferring device 120 in this embodiment is a conveying belt, and there may be one, two, or more conveying belts. It can be understood that in other embodiments, the transferring device 120 may also be other devices capable of realizing transferring, such as a conveying chain or a roller.

The guiding mechanism 130 may include a guiding plate. The guiding plate of this embodiment can cooperate with the UAV 200. When the guiding plate moves toward the transferring device 120, the UAV 200 can be pushed to move to the transferring device 120. More specifically, the UAV 200 may include a landing gear, and the guiding plate may abut or connect with the landing gear, thereby pushing the UAV 200 to move.

In one embodiment, referring to FIG. 2, FIG. 4, and FIG. 6, there are two conveying belts, that is, a first conveying belt and a second conveying belt, and the first conveying belt and the second conveying belt are spaced apart. The guiding mechanism 130 includes two guiding plates, that is, a first guiding plate and a second guiding plate, and the first guiding and the second guiding plate are positioned on both sides of the two conveying belts. The landing gear includes a first landing gear and a second landing gear. After the UAV 200 has landed in the first area 110, the first power device 140 can drive the first guiding plate and/or the second guiding plate to move, such that the first guiding plate can match with the first landing gear, and/or the second guiding plate can match with the second landing gear to push the first landing gear onto the first conveying belt and the second landing gear onto the second conveying belt.

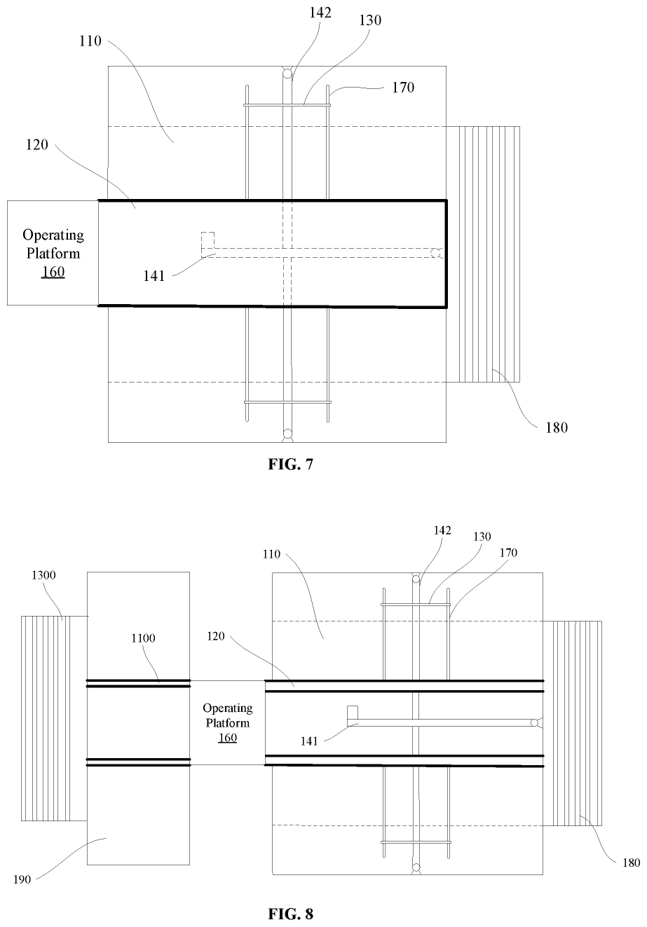

In another embodiment, referring to FIG. 7, there is one conveying belt, and the guiding mechanism 130 includes two guiding plates, that is, the first guiding plate and the second guiding plate, the first guiding plate and the second guiding plate are positioned on both sides of the conveying belt. The landing gear includes a first landing gear and a second landing gear. After the UAV 200 has landed in the first area 110, the first power device 140 can drive the first guiding plate and/or the second guiding plate to move to push the first landing gear and the second landing gear onto the conveying belt.

Further, the base station 100 also include a sliding rail 170, and the guiding plate can match with the sliding rail 170. The first power device 140 can drive the guiding plate to move, and the guiding plate can move along the sliding rail 170 to move toward or away from the transferring device 120.

The structure of the first power device 140 can be designed as needed. Referring to FIG. 6, the first power device 140 of this embodiment includes a power component 141 and a steel wire rope 142, and the steel wire rope 142 is connected to the guiding plate. The power component 141 can drive the steel wire rope 142 to move, and drive the guiding plate to move toward or away from the transferring device 120. In some embodiments, the power component 141 may be an electric pole, a motor, or other power devices. The steel wire rope 142 may be replaced with a rope of other materials. Further, the second power device 150 may be a motor or other power devices.

Referring to FIG. 3, FIG. 4, FIG. 6, and FIG. 7, the base station 100 further includes a first guiding part 180 disposed at the side of the first area 110 away from the operating platform 160, and used for guiding the 200 into the first area 110 or guiding the UAV 200 to take off from the first area 110.

The operating platform 160 of this embodiment can be used to perform one or more operations of updating the power source of the UAV 200, replacing parts of the UAV 200, supplementing the payload of the UAV 200, or exchanging data with the UAV 200. Of course, the operating platform 160 can also perform other operations. In some embodiments, the way the operating platform 160 updates the power source of the UAV 200 may need to be determined based on the type of the power source of the UAV 200. For example, in one embodiment, the power source of the UAV 200 is a battery, and the operating platform 160 can replace the battery of the UAV 200 or charge the battery of the UAV 200. In another embodiment, the power source of the UAV 200 is gasoline, and the operating platform 160 can refuel the fuel tank of the UAV 200. The parts of the UAV 200 may include the positioning device of the UAV 200 or other parts. The payload of the UAV 200 may include, but is not limited to, one or more of pesticides, water, or seeds. The pesticides may include liquid pesticides, and/or solid pesticides (such as powdered pesticides). In addition, the data exchanging between the operating platform 160 and the UAV 200 may include the operating platform 160 obtaining the data information of the UAV 200 from the UAV 200. The data information of the UAV 200 in this embodiment may include, but is not limited to one or more of image data information captured by an imaging device on the UAV 200, flight trajectory information of the UAV 200, and historical position data information of the UAV 200, or power information of the UAV 200. The data exchange between the operating platform 160 and the UAV 200 may further include the operating platform 160 upgrading the firmware of the UAV 200.

Further, after the operating platform 160 completes the operation of the UAV 200, the base station 100 can export the UAV 200 from the operating platform 160 to realize the automatic takeoff the UAV 200 again. More specifically, in one embodiment, after the operating platform 160 completes the operation on the UAV 200, the operating platform 160 can transfer the UAV 200 to the transferring device 120, the second power device 150 can drive the transferring device 120 to move to drive the UAV 200 back to the first area 110 again, and the UAV 200 can take off from the first area 110 automatically.

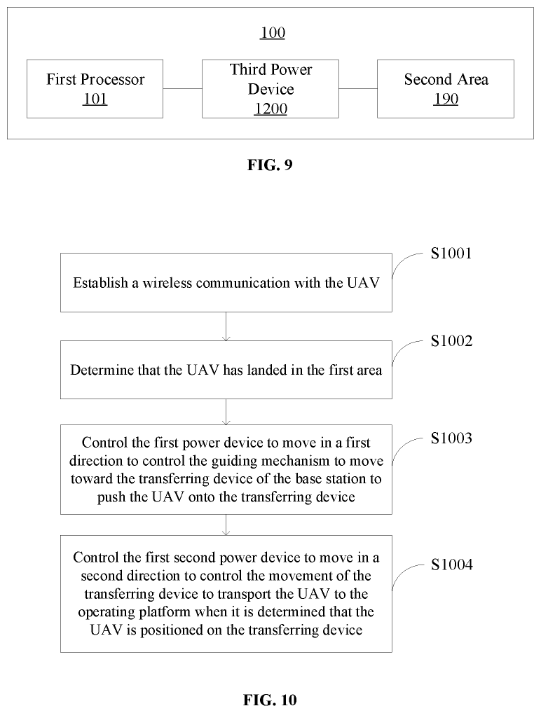

In another embodiment, referring to FIG. 8 and FIG. 9, the base station 100 further includes a second area 190, a transporting mechanism 1100, and a third power device 1200. In some embodiments, the first area 110 and the second area 190 may be respectively positioned on both sides of the operating platform 160. For example, the first area 110 may be positioned on a side of the operating platform 160, and the second area 190 may be positioned on a side of the operating platform 160 away from the first area 110. The transporting mechanism 1100 of this embodiment is disposed in the second area 190. In this embodiment, after the operating platform 160 completes the operation on the UAV 200, the operating platform 160 can transport the UAV 200 to the transporting mechanism 1100, and the third power device 1200 can drive the transporting mechanism 1100 to move to drive the UAV 200 into the second area 190, such that the UAV 200 can take off automatically from the second area 190.

Referring to FIG. 8 again, the base station 100 further includes a second guiding part 1300 disposed at the side of the second area 190 away from the operating platform 160, and used to guide the UAV 200 to take off form the second area 190.

A method for controlling a base station and a method for controlling a UAV will be described in detail below.

FIG. 10 is a flowchart of a method for controlling a base station according to an embodiment of the present disclosure. The execution body of the method for control the base station in this embodiment is the base station 100. More specifically, the execution body of the method for controlling the base station is the first processor 101. The first processor 101 may be the main controller of the base station 100, or other processors of the base station 100, or an independent controller disposed in the base station 100. The method for controlling the base station will be described in detail below.

S1001, establishing a wireless communication with the UAV 200.

In this embodiment, when the UAV 200 is positioned in a certain area around the base station 100, the UAV 200 can automatically access the base station 100 or the UAV 200 can request the base station 100 for a communication connection. After the base station 100 determines that the identity of the UAV 200 is valid (the base station 100 can determine the validity of the identity of the UAV 200 based on the ID of the UAV 200), the UAV 200 can be connected to the base station 100 to realize wireless communication between the base station 100 and the UAV 200. In some embodiments, the wireless communication method between the base station 100 and the UAV 200 may be Wi-Fi, Bluetooth, or other wireless communication methods.

S1002, determining that the UAV 200 has landed in the first area 110.

The base station 100 determining that the UAV 200 has landed in the base station 100 may include, but is not limited to, the following two methods.

The first method is related to the receipt of a landing completion signal sent by the UAV 200. The UAV 200 may be equipped with a second vision module (such as an image sensor, a binocular visual odometer, a monocular visual odometer, a visual inertial odometer (VIO), or a visual odometer (VO)). After the UAV 200 detects that the UAV 200 is positioned in the first area 110 based on the second vision module, the landing completion signal can be sent to the base station 100. The UAV 200 can determine its relative position relationship with the first area 110 through the second vision module, thereby determining whether the UAV 200 is landed on the first area 110.

In the second method, one or more of a positioning device (such as a RTK positioning group device), a first vision module (such as an image sensor, a binocular visual odometer, a monocular visual odometer, a visual inertial odometer (VIO), or a visual odometer (VO)), a gravity sensor, or a photoelectric sensor may be equipped in the first area 110. The base station 100 can detect that the UAV 200 is positioned on the first area 110 based on one or more of the positioning device, the first vision module, the gravity sensor, or the photoelectric sensor. More specifically, the position of the UAV 200 can be determined by the positioning device to determine the relative positional relationship between the UAV 200 and the first area 110, thereby determining whether the UAV 200 is positioned on the first area 110. The relative positional relationship between the UAV 200 and the first area 110 can also be determined through the images captured by the first vision module, thereby determining whether the UAV 200 is positioned on the first area 110. The gravity sensor can detect the weight of the first area 110, thereby determining whether the UAV 200 is positioned on the first area 110. The position of the UAV 200 can also be detected by the photoelectric sensor, thereby determining whether the UAV 200 is positioned on the first area 110. The base station 100 may also detect whether the UAV 200 is positioned on the first area 110 based on other devices.

In some embodiments, the base station 100 may use the first or the second method to determine whether the UAV 200 has landed in the base station 100. In other embodiments, the base station 100 may use the first and the second methods to determine whether the UAV 200 has landed in the first area 110.

In this embodiment, before the process at S1002, the base station 100 may need to determine whether the first area 110 is expanded relative to the operating platform 160. More specifically, the operating platform 160 may include an entrance, and the transferring device 120 may be adjacent to the entrance. The transferring device 120 may be configured to send the UAV 200 into the operating platform 160 from the entrance. The first area 110 of this embodiment may be positioned on a first cover, and the first cover may include an unfolded state and a folded state. In some embodiments, when the first cover is in the unfolded state, the UAV 200 can be sent into the operating platform 160 by the transferring device 120 on the first area 110; and when it is not needed, the first cover may be set to the folded state. In some embodiments, the first cover may be rotatably connected to the operating platform 160. The first cover may rotate relative to the operating platform 160 to be selectively in the unfolded state and the folded state. When the first cover is rotated relative to the operating platform 160 to the unfolded state, the base station 100 can automatically manage the UAV 200. When the first cover is rotated relative to the operating platform 160 to the folded state, the first cover may be disposed on the entrance. The first cover may be matched with an entrance cover, which can prevent moisture, dust, etc. from entering the operating platform 160. In some embodiments, a receiving groove may be disposed at the bottom of the operating platform 160, and the first cover may be movably inserted into the receive groove. When the first cover is inserted into the receiving groove, the first cover may be in the folded state. When the first cover moves relative to the receiving groove until the first area 110 of the first cover is outside the receiving groove, the first cover may be in the unfolded state.

Further, before the process at S1002, the base station 100 may also need to determine whether the first area 110 can let the UAV 200 land. In some embodiments, when the base station 100 determines that there is no UAV 200 that has landed in the first area 110 or determines that the area of the free area on the first area 110 is greater than a specific area value (the size of the specific area can at least be used to accommodate the current UAV 200 to be landed), it may determine that the first area 110 allows the UAV 200 to land.

In addition, in other embodiments, after receiving the landing request sent by the UAV 200, the base station 100 may determine whether the first area 110 is unfolded relative to the operating platform 160, and determine whether the first area 110 can let the UAV 200 land. When the UAV 200 of this embodiment detects that the UAV 200 meets a first predetermined strategy, it may send a landing request to the base station 100. In some embodiments, the first predetermined strategy may include one or more of the power source of the UAV 200 is insufficient, the parts of the UAV 200 are in a faulty state, the payload of the UAV 200 is insufficient, or the UAV 200 meets the conditions for data exchange with the base station 100. Of course, the first predetermined strategy may not limited to the methods listed above, and may also include other methods.

The UAV 200 of this embodiment may determine whether the power source of the UAV 200 is sufficient based on the type of its power source. In one embodiment, when the UAV 200 detects that the battery power of the UAV 200 is less than or equal to a predetermined first power threshold, the power source of the UAV 200 can be determined as insufficient. In another embodiment, when the UAV 200 detects that the fuel level of the UAV 200 is less than or equal to a predetermined first fuel level threshold, the power source of the UAV 200 may be deterred as insufficient. In some embodiments, the first power threshold and the first fuel level threshold may be set as needed.

The parts of the UAV 200 may include the positioning device of the UAV 200 or other parts. Take the positioning device of the UAV 200 as an example, when the UAV 200 detects that the positioning device of the UAV 200 cannot achieve positioning, the positioning device of the UAV 200 can be determined as in a faulty state.

Further, the UAV 200 may determine whether the payload of the UAV 200 is insufficient based on its payload type. In some embodiments, the payload of the UAV 200 may include one or more of pesticides, water, or seeds. When the UAV 200 detects one or more of a pesticide dosage of the UAV 200 is less than or equal to a predetermined first dosage threshold, a water volume of the UAV 200 is less than or equal to a predetermined first water volume threshold, or a seed volume of the UAV 200 is less than or equal to a predetermined first seed volume threshold, the payload of the UAV 200 can be determined as insufficient. The first dosage threshold, the first water volume threshold, and the first seed volume threshold can be set as needed. The pesticides may include liquid pesticides and/or solid pesticides (such as powdered pesticides).

The data exchange between the third power device 1200 and the base station 100 may include two links, that is, from the UAV 200 to the base station 100, and from the base station 100 to the UAV 200. When the UAV 200 detects that time between the current time and the time when the UAV 200 last exchanged data with the base station 100 meets a predetermined exchange period, or when the UAV 200 detects that the data volume of the data information of the UAV 200 is greater than or equal to a predetermined data volume threshold, or when the UAV 200 detects that the firmware of the UAV 200 needs to be updated (the UAV 200 detects that the firmware version is low or the UAV 200 receives a firmware upgrade reminder sent by the base station 100), the condition for data exchange with the base station 100 can be determined as met. In some embodiments, the data information of the UAV 200 may include one or more of the image data information captured by the imaging device on the UAV 200, the flight trajectory information of the UAV 200, or the historical position data information of the UAV 200. The data information of the UAV 200 may also include other data information collected by the UAV 200 or other data information during the operation of the UAV 200.

In this embodiment, after the base station 100 determines that the base station 100 is unfolded relative to the operating platform 160 and determines that the base station 100 can let the UAV 200 land, it may send a landing permission signal to the UAV 200 in response to the landing request, thereby triggering the UAV 200 to automatically land to the first area 110, and there is no need to manually trigger the UAV 200 to land.

S1003, controlling the first power device 140 to move toward a first direction to control the guiding mechanism 130 to move toward the transferring device 120 to push the UAV 200 to the transferring device 120.

More specifically, in one embodiment, when the base station 100 executes the process at S1003, when it is determined that the UAV 200 is positioned on the transferring device 120, it may control the first power device 140 to stop moving (e.g., by cutting off the power supply of the first power device 140) to save power. In another embodiment, when the base station 100 determines that the UAV 200 is positioned on the transferring device 120, it may not need to cut off the power supply of the first power device 140.

There are many methods to determine whether the UAV 200 is positioned on the transferring device 120. For example, in one embodiment, when it is determined that the guiding mechanism 130 moves to the first position toward the 120, the UAV 200 can be determined to be positioned on the transferring device 120. Take the transferring device 120 including the first conveying belt and the second conveying belt, and the guiding mechanism 130 including the first guiding plate and the second guiding plate as an example. When the guiding mechanism 130 is in the first position, the first guiding plate may abut against the side of the first conveying belt away from the second conveying belt, and the second guiding plate may abut against the side of the second conveying belt away from the first conveying belt, thereby sandwiching the first landing gear and the second landing gear between the first guiding plate and the second guiding plate, such that the first landing gear of the UAV 200 can be positioned on the first conveying belt, and the second landing gear can be positioned on the second conveying belt. The first power device 140 can simultaneously drive the first conveying belt and the second conveying belt to move, and transfer the UAV 200 to the operating platform 160. A first limit which may be disposed on the guiding mechanism 130 in this embodiment. When the guiding mechanism 130 moves to the first position, the first limit switch may output a first signal. When the base station 100 receives the first signal output by the first limit switch, it may determine that the guiding mechanism 130 is moving toward the transferring device 120 to the first position.

In this embodiment, before the UAV 200 descends to the first area 110, the guiding mechanism 130 may be positioned at a second position. In some embodiments, the distance from the second position to the conveying belt may be greater than the distance from the first position to the conveying belt to ensure that the base station 100 has a larger area for the UAV 200 to land.

After the base station 100 controls the first power device 140 to move in a second direction to control the transferring device 120 to move and transfer the UAV 200 to the operating platform 160, it may also control the first power device 140 to move toward a third direction, such that the guiding mechanism 130 can move away from the transferring device 120, and when it is determined that the guiding mechanism 130 is moving away from the transferring device 120 to the second position, the first power device 140 can be controlled to stop the movement. The guiding mechanism 130 may be reset to the second position to facilitate the landing of a new UAV 200 or send the UAV 200 to the base station 100 in the current period.

In this embodiment, the third direction may be opposite to the first direction. For example, in one embodiment, the first power device 140 may include a motor, the first direction may be a clockwise rotation direction, and the third direction may be a counterclockwise rotation direction. In this embodiment, a second limit switch may be disposed on the guiding mechanism 130. When the guiding mechanism 130 moves to the second position, the second limit switch may output a second signal. When the base station 100 receives the second signal output by the second limit switch, it may determine that the guiding mechanism 130 had moved away from the transferring device 120 to the second position.

S1004, controlling the second power device 150 to move toward the second direction to control the movement of the transferring device 120 to transfer the UAV 200 to the operating platform 160 when it is determined that the UAV 200 is positioned on the transferring device 120.

In this embodiment, when the base station 100 determines that the UAV 200 is transferred to the operating platform 160, it may control the second power device 150 to stop moving (e.g., by cutting off the power supply of the second power device 150) to save power. Of course, when the base station 100 determines that the UAV 200 is transferred to the operating platform 160, it may not need to cut off the power supply of the second power device 150, which can be specifically selected as needed.

A first photoelectric detection sensor may be disposed at a first designated position of the operating platform 160 in this embodiment. When the base station 100 determines that the first photoelectric detection sensor outputs a third signal, it may determine that the UAV 200 is transferred to the operating platform 160. In some embodiments, the first designated position may be located on the side of the operating platform 160 facing the base station 100 (i.e., at the entrance of the base station 100). The detection principle of the first photoelectric detection sensor for detecting whether the UAV 200 passes through the entrance may be the conventional technology. For example, the first photoelectric detection sensor may include a first light emitter and a first light receiver. The first light emitter may be disposed on one side of the entrance, and the first light receiver may be disposed on the other side of the entrance (e.g., the first light emitter may be positioned on the left side of the entrance, and the first light receiver may be positioned on the right side of the entrance; or, the first light emitter may be positioned at the top of the entrance, and the first light receiver may be positioned at the bottom of the entrance). When the UAV 200 does not pass the entrance, the first light emitter can cooperate with the first light receiver, and the first light receive may detect the light signal. When the UAV 200 passes through the first position, the first light emitter and the first light receiver may be blocked by the UAV 200, and the first light receiver may not detect the light signal. Of course, in other embodiments, other detection devices may also be disposed at the entrance to detect whether the UAV 200 enters or exits the operating platform 160 through the entrance.

Further, after the base station 100 of this embodiment controls the second power device 150 to move in the second direction to control the transferring device 120 to move and transfer the UAV 200 to the operating platform 160, if the request sent by the UAV 200 is received, the second power device 150 may be controlled to move in a fourth direction to control the movement of the transferring device 120 the to transfer the UAV 200 from the operating platform 160 to the first area 110. Therefore, after the operating platform 160 completes the operation on the UAV 200, the UAV 200 can be automatically sent out, and the UAV 200 can continue to perform tasks such as spraying, seeding, and shooting. In this embodiment, the fourth direction may be opposite to the second direction. For example, in one embodiment, the second power device 150 may include a motor, the second direction may be a clockwise rotation direction, and the fourth direction may be a counterclockwise rotation direction.

In this embodiment, the base station 100 can determine that the first photoelectric detection sensor output the third signal, and control the second power device 150 to move in the fourth direction.

In the above embodiment, the first area 110 can not only be used for the landing of the UAV 200, but can also be used for the UAV 200 to park when it is sent out. The landing and exiting of the UAV 200 can share the same area. This design method can save the space occupation of the base station 100, facilitate the miniaturization of the base station 100, and reduce the cost.

In another embodiment, referring to FIG. 8 and FIG. 9, the base station 100 also includes a second area 190, a transporting mechanism 1100 disposed in the second area 190, and a third power device 1200 for driving the transporting mechanism 1100 to move. The second area 190 and the first area 110 may be respectively positioned on both sides of the operating platform 160, and the operating platform 160 may be adjacent to one end of the transporting mechanism 1100.

In this embodiment, after the base station 100 controls the second power device 150 to move in the second direction to control the transferring device 120 to move and transfer the UAV 200 to the operating platform 160, if the request sent by the UAV 200 is received, the third power device 1200 may be controlled to move to control the movement of the first area 110 to convey the UAV 200 from the operating platform 160 to the second area 190.

A second photoelectric detection sensor may be disposed at a second designated position of the operating platform 160. The second designated position may be located on the side of the operating platform 160 facing the second area 190 (such as the exit of the operating platform 160). After determining that the second photoelectric detection sensor outputs the fourth signal, the base station 100 of this embodiment can control the third power device 1200 to move.

The detection principle of the second photoelectric detection sensor detecting whether the UAV 200 passes through the entrance may be the conventional technology. For example, the second photoelectric detection sensor may include a second light emitter and a second light receiver. The second light emitter may be disposed on one side of the entrance, and the second light receiver may be disposed on the other side of the entrance (e.g., the second light emitter may be positioned on the left side of the entrance, and the second light receiver may be positioned on the right side of the entrance; or, the second light emitter may be positioned at the top of the entrance, and the second light receiver may be positioned at the bottom of the entrance). When the UAV 200 does not pass the entrance, the second light emitter can cooperate with the second light receiver, and the second light receive may detect the light signal. When the UAV 200 passes through the second position, the second light emitter and the second light receiver may be blocked by the UAV 200, and second first light receiver may not detect the light signal. Of course, in other embodiments, other detection devices may also be disposed at the entrance to detect whether the UAV 200 enters or exits the operating platform 160 through the entrance.

After determining that the second area 190 is unfolded relative to the operating platform 160, and determining that the second area 190 can accommodate the UAV 200 to enter, the base station 100 may control the movement of the third power device 1200. More specifically, the transporting mechanism 1100 may be adjacent to the entrance. After the interaction between the operating platform 160 and the UAV 200 is completed, the UAV 200 can be transported from the operating platform 160 to the transporting mechanism 1100 through the entrance. The second area 190 of this embodiment may be positioned on a second cover, and the second cover may include an unfolded state and a folded state. In some embodiments, when the second cover is in the unfolded state, the UAV 200 can be transported to the first area 110 by the operating platform 160, and the first area 110 can transport the UAV 200 to the second area 190. When it is not needed, the second cover can be set to the folded state. In some embodiments, the second cover may be rotatably connected to the operating platform 160. The second cover may rotate relative to the operating platform 160, such that it can be selectively in the unfolded state and the folded state. When the second cover rotates to the unfolded state relative to the operating platform 160, the base station 100 can automatically manage the UAV 200. When the second cover rotates relative to the operating platform 160 to the folded state, the second cover may be disposed on the entrance. The second cover can match with the entrance cover, and can prevent moisture, dust, etc. from entering the operating platform 160. In some embodiments, a receiving groove may be disposed at the bottom of the operating platform 160, and the second cover may be movably inserted into the receiving groove. When the second cover is inserted into the receiving groove, the second cover may be in the folded state. When the second cover moves relative to the receiving groove until the second area 190 of the second plate is outside the receiving groove, the second cover may be in the unfolded state.

When the base station 100 determines that there is no UAV 200 to fly out in the second area 190 or determines that the area of the free area on the second area 190 is greater than a specific area value (the size of the specific area can at least be used to accommodate the current UAV 200 to be flown out), it may determine that the second area 190 allows the UAV 200 to land.

In the embodiment described above, when the UAV 200 detects that the UAV 200 meets a second predetermined strategy, it may send a request to the base station 100 to trigger the base station 100 to carry out the operation for transporting the UAV 200 on the operating platform 160 to the first area 110 or the second area 190.

In this embodiment, when the UAV 200 determines that the UAV 200 is positioned on the operating platform 160, it may determine that the UAV 200 meets the second predetermined strategy. Further, The UAV 200 may determine that the UAV 200 meets the second predetermined strategy when the UAV 200 detects one or more of the following conditions: the power source of the UAV 200 is sufficient, the parts of the UAV 200 have changed from a faulty state to a normal state, the payload of the UAV 200 is sufficient, or the UAV 200 and the base station 100 have completed the data exchange.

In some embodiments, when the UAV 200 detects that the battery power of the UAV 200 is greater than or equal to a predetermined second power threshold, it may determine that the power source of the UAV 200 is sufficient. The second power threshold may be set as needed. In some embodiments, when the UAV 200 detects that the amount of fuel in the fuel tank of the UAV 200 is greater than or equal to a predetermined second fuel amount threshold, it may determine that the power source of the UAV 200 is sufficient. The second fuel amount threshold may be set as needed.

The UAV 200 may determine that the payload of the UAV 200 is sufficient when it detects one or more of the pesticide dosage of the UAV 200 is greater than or equal to a predetermined second dosage threshold, the water volume of the UAV 200 is greater than or equal to a predetermined second water volume threshold, or the seed volume of the UAV 200 is greater than or equal to a predetermined second seed volume threshold. The second dosage threshold, the second water volume threshold, and the second seed volume threshold in this embodiment can be set based on needs.

In one embodiment, at the same time, the base station 100 may only interact with one UAV 200 to realize the automation of the landing, the power source replacement, the parts maintenance, the payload supplement, the data exchange, and the sending of the UAV 200. In another embodiment, at the same time, the UAV 200 may interact with a plurality of UAVs 200 to realize the automation of the landing, the power source replacement, the parts maintenance, the payload supplement, the data exchange, and the sending of the UAVs 200, thereby satisfying the operating needs of the UAVs 200.

In addition, when the guiding mechanism moves to the first position, and the first limit switch does not output a signal or the output signal is not the first signal; the guiding mechanism moves to the second position, and the second limit switch does not output a signal or the output signal is not the second signal; the UAV passes the entrance, and the first photoelectric detection sensor does not output a signal or the output signal is not the third signal; or, the UAV passes the entrance, and the second photoelectric detection sensor does not output a signal or the output signal is not the fourth signal, the base station may generate an alarm signal to remind the user that there is an issue with the sensor system of the base station. In some embodiments, the alarm signal may include one or more of a light signal, an acoustic signal, or other alarm signals.

In the base station control method of this embodiment of the present disclosure, by setting the guiding mechanism 130 on the base station 100, even if there is a relative large error in the position of the UAV 200 landing on the base station 100, the base station 100 can still push the UAV 200 to the transferring device 120 through the guiding mechanism 130 and transport the UAV 200 to the operating platform 160, thereby realizing the automation of UAV recovery, which provides the basis for the process of power source update, parts maintenance, payload supplement, data exchange, and other processes of the UAV 200, thereby realizing the automation of the process of landing, power source replacement, payload change, parts repair, and data exchange of the UAV 200, which solves the current situation of the UAV 200 needing human intervention in the process of landing, power source replacement, payload change, parts repair, and data exchange.

FIG. 11 is a flowchart of a method for controlling a UAV according to an embodiment of the present disclosure. The execution body of the method for control the UAV in this embodiment is the UAV 200. More specifically, the execution body of the method for controlling the UAV is a second processor 201. The second processor 201 may be the flight controller of the UAV 200, or may be another processor on the UAV 200, or an independent controller disposed on the UAV 200. The method for controlling the UAV will be described in detail below.

S1101, establishing a wireless communication with the base station 100.

In this embodiment, when the UAV 200 is positioned in a certain area around the base station 100, the UAV 200 can automatically access the base station 100 or the UAV 200 can request the base station 100 for a communication connection. After the base station 100 determines that the identity of the UAV 200 is valid (the base station 100 can determine the validity of the identity of the UAV 200 based on the ID of the UAV 200), the UAV 200 can be connected to the base station 100 to realize the wireless communication between the base station 100 and the UAV 200. In some embodiments, the wireless communication method between the base station 100 and the UAV 200 may be Wi-Fi, Bluetooth, or other wireless communication methods.

S1102, sending a landing request to the base station 100 in response to detecting the UAV 200 meeting the first predetermined strategy.

More specifically, the UAV 200 may determine that the UAV 200 meets the first predetermined strategy when the UAV 200 detects one or more of the following conditions: the power source of the UAV 200 is insufficient, the parts of the UAV 200 are in the faulty state, the payload of the UAV 200 is insufficient, or the UAV 200 meets the condition for data exchange with the base station 100. Of course, the first predetermined strategy may not limited to the methods listed above, and may also include other methods.

The UAV 200 of this embodiment may determine whether the power source of the UAV 200 is sufficient based on the type of its power source. In one embodiment, when the UAV 200 detects that the battery power of the UAV 200 is less than or equal to a predetermined first power threshold, the power source of the UAV 200 can be determined as insufficient. In another embodiment, when the UAV 200 detects that the fuel level of the UAV 200 is less than or equal to a predetermined first fuel level threshold, the power source of the UAV 200 may be determined as insufficient. In some embodiments, the first power threshold and the first fuel level threshold may be set as needed.

The parts of the UAV 200 may include the positioning device of the UAV 200 or other parts. Take the positioning device of the UAV 200 as an example, when the UAV 200 detects that the positioning device of the UAV 200 cannot achieve positioning, the positioning device of the UAV 200 can be determined as in a faulty state.

Further, the UAV 200 may determine whether the payload of the UAV 200 is insufficient based on its payload type. In some embodiments, the payload of the UAV 200 may include one or more of pesticides, water, or seeds. When the UAV 200 detects one or more of a pesticide dosage of the UAV 200 is less than or equal to a predetermined first dosage threshold, a water volume of the UAV 200 is less than or equal to a predetermined first water volume threshold, or a seed volume of the UAV 200 is less than or equal to a predetermined first seed volume threshold, the payload of the UAV 200 can be determined as insufficient. The first dosage threshold, the first water volume threshold, and the first seed volume threshold can be set as needed. The pesticides may include liquid pesticides and/or solid pesticides (such as powdered pesticides).

The data exchange between the third power device 1200 and the base station 100 may include two links, that is, from the UAV 200 to the base station 100, and from the base station 100 to the UAV 200. When the UAV 200 detects that time between the current time and the time when the UAV 200 last exchanged data with the base station 100 meets a predetermined exchange period, or when the UAV 200 detects that the data volume of the data information of the UAV 200 is greater than or equal to a predetermined data volume threshold, or when the UAV 200 detects that the firmware of the UAV 200 needs to be updated (the UAV 200 detects that the firmware version is low or the UAV 200 receives a firmware upgrade reminder sent by the base station 100), the condition for data exchange with the base station 100 can be determined as met. In some embodiments, the data information of the UAV 200 may include one or more of the image data information captured by the imaging device on the UAV 200, the flight trajectory information of the UAV 200, or the historical position data information of the UAV 200. The data information of the UAV 200 may also include other data information collected by the UAV 200 or other data information during the operation of the UAV 200.

S1103, receiving the landing permission signal returned by the base station 100 in response to the landing request.

In this embodiment, the UAV 200 may be equipped with a second vision module (such as an image sensor, a binocular visual odometer, a monocular visual odometer, a visual inertial odometer (VIO), or a visual odometer (VO)). After the UAV 200 detects that the UAV 200 is positioned in the first area 110 based on the second vision module, the landing completion signal can be sent to the base station 100 to trigger the base station 100 to carry out the operation for transporting the UAV 200 to the operating platform 160. The UAV 200 can determine its relative position relationship with the first area 110 through the second vision module, thereby determining whether the UAV 200 is landed on the first area 110.

S1104, controlling the UAV 200 to land to the first area 110 of the base station 100 to trigger the base station 100 to carry out the operation for transporting the UAV 200 to the operating platform 160.

In some embodiments, the operating platform 160 may be configured to perform one or more of the operations of updating the power source of the UAV 200, replacing the parts of the UAV 200, supplementing the payload of the UAV 200, and performing data exchange with the UAV 200. For details, reference may be made to the description of the part corresponding to the operating platform 160 in the foregoing embodiment, which will not be repeated here.

In this embodiment, the UAV 200 may be controlled to land to the first area 110 based on a predetermined flight speed. The UAV 200 can be controlled to land to the first guiding part 180 first, and then the UAV 200 can be controlled to slide from the first guiding part 180 to the first area 110.

In one embodiment, the method for controlling the UAV may further include, in response to detecting the UAV 200 meeting the second predetermined strategy, sending a request to the base station 100 to trigger the base station 100 to perform the operation for transporting the UAV 200 on the operating platform 160 to the first area 110. In addition, after the UAV 200 sends out the request to the base station 100, it may also need to determine whether the UAV 200 is positioned in the first area 110.

In some embodiments, the UAV 200 may detect that the UAV 200 is positioned on the first area 110 based on the second vision module, thereby determining that the UAV 200 is positioned on the first area 110. In some embodiments, the UAV 200 may receive the completion signal sent by the base station 100 to indicate that the UAV 200 is positioned on the first area 110. In this embodiment, one or more of a positioning device (such as a RTK positioning group device), a first vision module (such as an image sensor, a binocular visual odometer, a monocular visual odometer, a visual inertial odometer (VIO), or a visual odometer (VO)), a gravity sensor, or a photoelectric sensor may be equipped in the first area 110. The base station 100 can detect that the UAV 200 is positioned on the first area 110 based on one or more of the positioning device, the first vision module, the gravity sensor, or the photoelectric sensor, and send the completion signal to the UAV 200. More specifically, the position of the UAV 200 can be determined by the positioning device to determine the relative positional relationship between the UAV 200 and the first area 110, thereby determining whether the UAV 200 is positioned on the first area 110. The relative positional relationship between the UAV 200 and the first area 110 can also be determined through the images captured by the first vision module, thereby determining whether the UAV 200 is positioned on the first area 110. The gravity sensor can detect the weight of the first area 110, thereby determining whether the UAV 200 is positioned on the first area 110. The position of the UAV 200 can also be detected by the photoelectric sensor, thereby determining whether the UAV 200 is positioned on the first area 110. Of course, the base station 100 may also detect whether the UAV 200 is positioned on the first area 110 based on other devices.

Further, after determining that the UAV 200 is position in the first area 110, the UAV 200 may control the UAV 200 to fly. In some embodiments, the UAV 200 can move from the first area 110 to the first guiding part 180, and then fly out by the first guiding part 180. More specifically, the UAV 200 can fly autonomously based on a predetermined trajectory, or, after flying out of the first area 110, the UAV 200 can fly based on the user instructions.

In another embodiment, the base station 100 may include a second area 190, and the first area 110 and the second area 190 may be respectively positioned on both sides of the operating platform 160. When the UAV 200 of this embodiment detects that the UAV 200 meets the second predetermined strategy, it can send a request to the base station 100 to trigger the base station 100 to perform the operation for transporting the UAV 200 on the operating platform 160 to the second area 190. In addition, after the UAV 200 sends out the request to the base station 100, it may need to determine whether the UAV 200 is positioned in the second area 190.

In some embodiments, the UAV 200 may detect that the UAV 200 is positioned on the second area 190 based on the second vision module, thereby determining that the UAV 200 is positioned on the second area 190. In some embodiments, the UAV 200 may receive the completion signal sent by the base station 100 to indicate that the UAV 200 is positioned on the second area 190. In this embodiment, one or more of a positioning device (such as a RTK positioning group device), a second vision module (such as an image sensor, a binocular visual odometer, a monocular visual odometer, a visual inertial odometer (VIO), or a visual odometer (VO)), a gravity sensor, or a photoelectric sensor may be equipped in the first area 110. The base station 100 can detect that the UAV 200 is positioned on the second area 190 based on one or more of the positioning device, the first vision module, the gravity sensor, or the photoelectric sensor, and send the completion signal to the UAV 200. More specifically, the position of the UAV 200 can be determined by the positioning device to determine the relative positional relationship between the UAV 200 and the second area 190, thereby determining whether the UAV 200 is positioned on the second area 190. The relative positional relationship between the UAV 200 and the second area 190 can also be determined through the images captured by the first vision module, thereby determining whether the UAV 200 is positioned on the second area 190. The gravity sensor can detect the weight of the second area 190, thereby determining whether the UAV 200 is positioned on the second area 190. The position of the UAV 200 can also be detected by the photoelectric sensor, thereby determining whether the UAV 200 is positioned on the second area 190. Of course, the base station 100 may also detect whether the UAV 200 is positioned on the second area 190 based on other devices.

Further, after the UAV 200 determines that the UAV 200 is positioned in the second area 190, it may control the UAV 200 to fly. In some embodiments, the UAV 200 can move from the second area 190 to the second guiding part 1300, and then fly out by the second guiding part 1300. More specifically, the UAV 200 can fly autonomously based on a predetermined trajectory, or, after flying out of the second area 190, the UAV 200 can fly based on the user instructions.

In this embodiment, when the UAV 200 determines that the UAV 200 is positioned on the operating platform 160, it may determine that the UAV 200 meets the second predetermined strategy. Further, The UAV 200 may determine that the UAV 200 meets the second predetermined strategy when the UAV 200 detects one or more of the following conditions: the power source of the UAV 200 is sufficient, the parts of the UAV 200 have changed from a faulty state to a normal state, the payload of the UAV 200 is sufficient, or the UAV 200 and the base station 100 have completed the data exchange.

In some embodiments, when the UAV 200 detects that the battery power of the UAV 200 is greater than or equal to a predetermined second power threshold, it may determine that the power source of the UAV 200 is sufficient. The second power threshold may be set as needed. In some embodiments, when the UAV 200 detects that the amount of fuel in the fuel tank of the UAV 200 is greater than or equal to a predetermined second fuel amount threshold, it may determine that the power source of the UAV 200 is sufficient. The second fuel amount threshold may be set as needed.

The UAV 200 may determine that the payload of the UAV 200 is sufficient when it detects one or more of the pesticide dosage of the UAV 200 is greater than or equal to a predetermined second dosage threshold, the water volume of the UAV 200 is greater than or equal to a predetermined second water volume threshold, or the seed volume of the UAV 200 is greater than or equal to a predetermined second seed volume threshold. The second dosage threshold, the second water volume threshold, and the second seed volume threshold in this embodiment can be set based on needs.

In one embodiment, at the same time, the base station 100 may only interact with one UAV 200 to realize the automation of the landing, the power source replacement, the parts maintenance, the payload supplement, the data exchange, and the sending of the UAV 200. In another embodiment, at the same time, the UAV 200 may interact with a plurality of UAVs 200 to realize the automation of the landing, the power source replacement, the parts maintenance, the payload supplement, the data exchange, and the sending of the UAVs 200, thereby satisfying the operating needs of the UAVs 200.

In addition, after the UAV 200 controls the UAV 200 to fly, it may also send a takeoff signal to the base station 100 to inform the base station 100 that the UAV 200 has completed the sending task. The base station 100 can continue to perform the other workflows of landing, power source replacement, parts maintenance, payload supplement, data exchange, or fly of the next UAV 200.

In addition, if the base station 100 does not receive the takeoff signal sent by the UAV 200 after the UAV 200 is flown out, the base station 100 may generate an alarm signal to remind the user that the base station 100 and the UAV 200 may have an interaction issue. The alarm signal may include one or more of a light signal, an acoustic signal, or other alarm signals.

In the UAV control method of this embodiment of the present disclosure, by setting the guiding mechanism 130 on the base station 100 that cooperates with the UAV 200, even if there is a relative large error in the position of the UAV 200 landing on the base station 100, the base station 100 can still push the UAV 200 to the transferring device 120 through the guiding mechanism 130 and transport the UAV 200 to the operating platform 160, thereby realizing the automation of UAV recovery, which provides the basis for the process of power source update, parts maintenance, payload supplement, data exchange, and other processes of the UAV 200, thereby realizing the automation of the process of landing, power source replacement, payload change, parts repair, and data exchange of the UAV 200, which solves the current situation of the UAV 200 needing human intervention in the process of landing, power source replacement, payload change, parts repair, and data exchange.

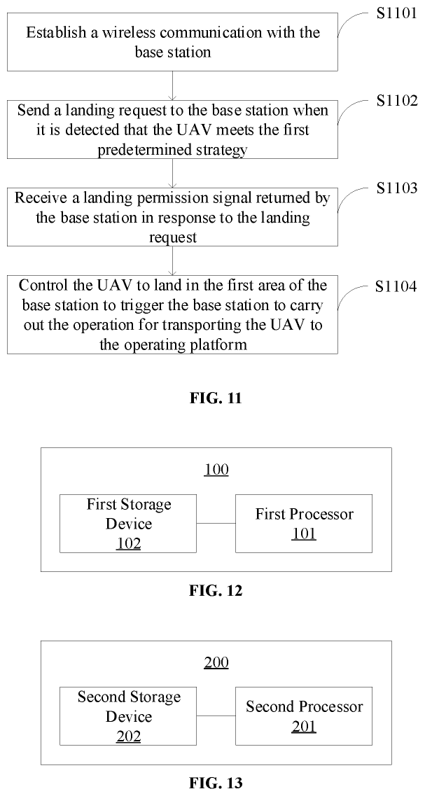

Corresponding to the base station control method described above, an embodiment of the present disclosure further provides a base station 100. Referring to FIG. 12, the base station includes a first processor 101 and a first storage device 102, where the first processor 101 is electrically connected to the first power device 140 and the second power device 150, respectively.

The first processor 101 in this embodiment may be a central processing unit (CPU). The first processor 101 may further include a hardware chip. The hardware chip may be an application specific integrated circuit (ASIC), a programmable logic device (PLD), or a combination thereof. The PLD described above may be a complex programmable logic device (CPLD), a field-programmable gate array (FPGA), a generic array logic (GAL) or any combination thereof.

The first storage device 102 may include a volatile memory, such as a random-access memory (RAM). The first storage device 102 may also include a non-volatile memory, such as a flash memory, a hard disk drive (HDD), or a solid-state drive (SSD). The first storage device 102 may also include a combination of the aforementioned types of memories.

In this embodiment, the first processor 101 can be configured to implement the base station control method as shown in FIG. 10.

More specifically, the first storage device 102 can be configured to store program instructions. The first processor 101 can be configured to execute the program instructions stored in the first storage device 102. When executed by the first processor 101, the program instructions can cause the first processor 101 to establish a wireless communication with the UAV 200; detect whether the UAV 200 has landed in the first area 110; control the first power device 140 to move toward the first direction to control the guiding mechanism 130 to move toward the transferring device 120 to push the UAV 200 to the transferring device 120; control the second power device 150 to move in the second direction to control the transferring device 120 to move to transport the UAV 200 to the operating platform 160 in response to determining that the UAV 200 is positioned on the transferring device 120.

For the working process of the first processor 101, reference can be made to the description of the foregoing embodiments, which will not be repeated here.

Corresponding to the UAV control method of the previous embodiment, an embodiment of the present disclosure further provides a UAV 200. Referring to FIG. 13, the UAV 200 further includes a second processor 201 and a second storage device 202.

The second processor 201 in this embodiment may be a central processing unit (CPU). The second processor 201 may further include a hardware chip. The hardware chip may be an application specific integrated circuit (ASIC), a programmable logic device (PLD), or a combination thereof. The PLD described above may be a complex programmable logic device (CPLD), a field-programmable gate array (FPGA), a generic array logic (GAL) or any combination thereof.

The second storage device 202 may include a volatile memory, such as a random-access memory (RAM). The second storage device 202 may also include a non-volatile memory, such as a flash memory, a hard disk drive (HDD), or a solid-state drive (SSD). The second storage device 202 may also include a combination of the aforementioned types of memories.

In this embodiment, the second processor 201 can be configured to implement the UAV control method as shown in FIG. 11.

More specifically, the second storage device 202 can be configured to store program instructions. The second processor 201 can be configured to execute the program instructions stored in the second storage device 202. When executed by the second processor 201, the program instructions can cause the second processor 201 to establish a wireless communication with the base station 100; receive the landing permission signal returned by the base station 100 in response to the landing request; and control the UAV 200 to land on the first area 110 of the base station 100 to trigger the base station 100 to carry out the operation for transporting the UAV 200 to the operating platform 160. In some embodiments, the operating platform 160 may be configured to perform one or more of the operations of updating the power source of the UAV 200, replacing the parts of the UAV 200, supplementing the payload of the UAV 200, and performing data exchange with the UAV 200

For the working process of the second processor 201, reference can be made to the description of the foregoing embodiments, which will not be repeated here

Referring to FIG. 1, an embodiment of the present disclosure further provides a UAV system including a UAV 200 and a base station 100, the UAV 200 cooperating with the base station 100. The base station 100 includes a first area 110, a transferring device 120, disposed in the first area 110, a guiding mechanism 130 movably disposed relative to the transferring device 120, a first power device 140 for driving the guiding mechanism 130 to move, a second power device 150 for driving the transferring device 120 to move, and an operating platform 160 adjacent to one end of the transferring device 120. In some embodiments, the operating platform 160 may be configured to perform one or more of the operations of updating the power source of the UAV 200, replacing the parts of the UAV 200, supplementing the payload of the UAV 200, and performing data exchange with the UAV 200

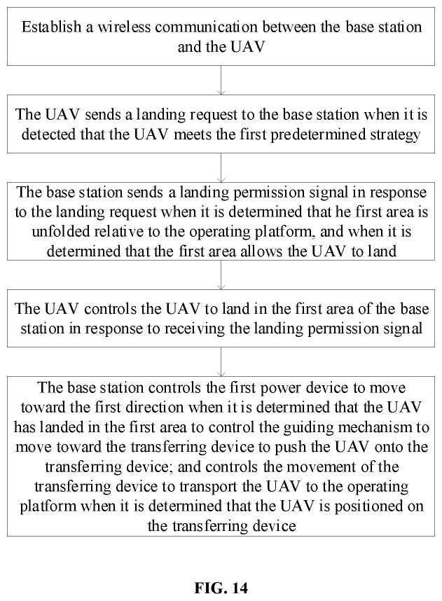

Referring to FIG. 14, the workflow of the UAV system includes but is not limited to the processes of establishing a wireless communication between the base station 100 and the UAV 200; and sending a landing request to the base station 100 when the UAV 200 detects that the UAV 200 meets the first predetermined strategy.

The base station 100 can be used to determine whether the first area 110 is unfolded relative to the operating platform 160, and when it is determined that the first area 110 can let the UAV 200 land, a landing permission signal can be sent to the UAV 200 in response to the landing request.

The UAV 200 can be used to control the UAV 200 to land in the first area 110 of the base station 100 in response to receiving the landing permission signal.

The base station 100 can be used to control the first power device 140 to move toward the first direction when it is determined that the UAV 200 has landed in the first area 110, thereby controlling the guiding mechanism 130 to move toward the transferring device 120 to push the UAV 200 to the transferring device 120

In some embodiments, the UAV 200 may determine that the UAV 200 meets the first predetermined strategy when the UAV 200 detects one or more of the following conditions: the power source of the UAV 200 is insufficient, the parts of the UAV 200 are in the faulty state, the payload of the UAV 200 is insufficient, or the UAV 200 meets the condition for data exchange with the base station 100.

In some embodiments, the UAV 200 may determine the power source of the UAV 200 is insufficient when it detects that battery level of the UAV 200 is less than or equal to the predetermined first power threshold, or when it detects that the fuel level of the UAV 200 is less than or equal to the first fuel level threshold.

In some embodiments, the UAV 200 may determine the payload of the UAV 200 is insufficient when it detects one or more of the pesticide dosage of the UAV 200 is less than or equal to the predetermined first dosage threshold, the water volume of the UAV 200 is less than or equal to the predetermined first water threshold, or the seed volume of the UAV 200 is less than or equal to the predetermined first seed volume threshold.

In some embodiments, the pesticides may include one or more of liquid pesticides or solid pesticides.

In some embodiments, the UAV 200 may determine that the UAV 200 meets the condition for data exchange with the base station 100 when it detects that the time between the current time and the time when the UAV 200 last exchanged data with the base station 100 meets a predetermined exchange period, or when the UAV 200 detects that the data volume of the data information of the UAV 200 is greater than or equal to a predetermined data volume threshold. In some embodiments, the data information of the UAV 200 may include one or more of the image data information captured by the imaging device on the UAV 200, the flight trajectory information of the UAV 200, or the historical position data information of the UAV 200.

In some embodiments, the base station 100 may be configured to determine that the UAV 200 has landed in the first area 110 in response to receiving the landing completion signal sent by the UAV 200. The first area 110 may include one or more of a positioning device, a first vision module, a gravity sensor, or a photoelectric sensor. The base station 100 may be configured to determine that the UAV 200 has landed in the first area 110 in response to one or more of the positioning device, the first vision module, the gravity sensor, or the photoelectric sensor detecting that the UAV 200 is positioned in the first area 110.

In some embodiments, the UAV 200 may further include a second vision module. The landing completion signal may be sent by the UAV 200 based on the second vision module detecting that the UAV 200 is positioned on the first area 110.

In some embodiments, the base station 100 may be configured to control the first power device 140 to stop moving when it is determined that the UAV 200 is positioned on the transferring device 120.

In some embodiments, the base station 100 may be configured to determine that the UAV 200 is positioned on the transferring device 120 when it is determined that the guiding mechanism 130 is moving to the first position toward the transferring device 120.

In some embodiments, a first limit switch may be disposed on the guiding mechanism 130. When the guiding mechanism 130 moves to the first position, the first limit switch may output a first signal.

In some embodiments, the base station 100 may be configured to determine that the guiding mechanism 130 is moving to the first position toward transferring device 120 in response to receiving the first signal from the first limit switch.

In some embodiments, after the base station 100 of this embodiment controls the second power device 150 to move in the second direction to control the transferring device 120 to move and transfer the UAV 200 to the operating platform 160, the base station 100 may be further configured to control the first power device 140 to move toward the third direction, such that the guiding mechanism 130 can move away from the transferring device 120, the third direction being opposite to the first direction; and control the first power device 140 to stop moving when it is determined that the guiding mechanism 130 is moving away from the transferring device 120 to the second position.

In some embodiments, a second limit switch may be disposed on the guiding mechanism 130. When the guiding mechanism 130 moves to the second position, the second limit switch may output a second signal. The base station 100 may be configured to determine that the guiding mechanism 130 is moving away from the transferring device 120 to the second position in response to receiving the second signal from the second limit switch.

In some embodiments, the base station 100 may be configured to control the second power device 150 to stop moving when it is determined that the UAV 200 is transported to the operating platform 160.

In some embodiments, a first photoelectric detection sensor may be disposed at the first designated position of the operating platform 160. The base station 100 may be configured to determine that the UAV 200 is transported to the operating platform 160 when it is determined that the first photoelectric detection sensor has output the third signal.

In some embodiments, the first designated position may be located on the side of the operating platform 160 facing the first area 110.

In some embodiments, after the base station 100 controls the second power device 150 to move in the second direction to control the transferring device 120 to move and transport the UAV 200 to the operating platform 160, the UAV 200 may send a request to the base station 100 when the UAV 200 detects that the UAV 200 meets the second predetermined strategy. After receiving the request sent by the UAV 200, the base station 100 may control the second power device 150 to move in the fourth direction to control the transferring device 120 to move to transport the UAV 200 from the operating platform 160 to the first area 110, the fourth direction being opposite to the second direction.

In some embodiments, after the receiving the sending out request sent by the UAV 200 and before controlling the second power device 150 to move in the fourth direction, the base station 100 may be further configured to determine again that the first photoelectric detection sensor has output the third signal.

In some embodiments, the base station 100 may further include a second area 190, a transporting mechanism 1100 disposed in the second area 190, and a third power device 1200 for driving the transporting mechanism 1100 to move. The second area 190 and the first area 110 may be respectively positioned on both sides of the operating platform 160, and the operating platform 160 may be adjacent to one end of the transporting mechanism 1100. After the base station 100 controls the second power device 150 to move in the second direction to control the transferring device 120 to move and transport the UAV 200 to the operating platform 160, the UAV 200 may send a request to the base station 100 when the UAV 200 detects that the UAV 200 meets the second predetermined strategy. After receiving the sending out request sent by the UAV 200, the base station 100 may control the movement of the third power device 1200 to control the movement of the transporting mechanism 1100 to transport the UAV 200 from the operating platform 160 to the second area 190.

In some embodiments, a second photoelectric detection sensor may be disposed at a second designated position of the operating platform 160. The second designated position may be located on the side of the operating platform 160 facing the second area 190. After receiving the sending out request sent by the UAV 200 and before controlling the movement of the third power device 1200, the base station 100 may be further configured to determine that the second photoelectric detection sensor outputs the fourth signal.

In some embodiments, after receiving the sending out request sent by the UAV 200 and before controlling the movement of the third power device 1200, the base station 100 may be further configured to determine that the second area 190 is unfolded relative to the operating platform 160, and determine that the second area 190 can let the UAV 200 enter.

In some embodiments, the UAV 200 may be configured to determine that the UAV 200 meets the second predetermined strategy when it is determined that the UAV 200 is positioned on the operating platform 160.

In some embodiments, the UAV 200 may be further configured to determine that the UAV 200 meets the second predetermined strategy when it detects one or more of the power source of the UAV 200 is sufficient, the parts of the UAV 200 have changed from the faulty state to the normal state, the payload of the UAV 200 is sufficient, or the UAV 200 and the base station 100 have completed the data exchange.

In some embodiments, the UAV 200 may be configured to determine that the power source of the UAV 200 is sufficient when it detects that the battery level of the UAV 200 is greater than or equal to the predetermined second power threshold, or the fuel level in the fuel tank of the UAV 200 is greater than or equal to the predetermined second fuel level threshold.

In some embodiments, the UAV 200 may be configured to determine that the payload of the UAV 200 is sufficient when it detects one or more of the pesticide dosage of the UAV 200 is greater than or equal to the predetermined second dosage threshold, the water volume of the UAV 200 is greater than or equal to the predetermined second water volume threshold, or the seed amount of the UAV 200 is greater than or equal to the predetermined second seed amount threshold.

In some embodiments, updating the power source of the UAV 200 may include replacing the battery of the UAV 200, charging the battery of the UAV 200, or refueling the fuel tank of the UAV 200.

In some embodiments, the payload of the UAV 200 may include one or more of pesticides, water, or seeds.

In some embodiments, the pesticides may include one or more of liquid pesticides or solid pesticides.

In some embodiments, performing data exchange with the UAV 200 may include obtaining data information of the UAV 200 from the UAV 200. In some embodiments, the data information of the UAV 200 may include one or more of the image data information captured by the imaging device on the UAV 200, the flight trajectory information of the UAV 200, the historical position data information of the UAV 200, or the battery information of the UAV 200.

In some embodiments, after the base station 100 controls the second power device 150 to move in the fourth direction, the UAV 200 may enter the automatic flight procedure when it determines that the UAV 200 is positioned in the first area 110 or the second area 190.

In some embodiments, the UAV 200 may include a second vision module. The UAV 200 may be configured to determine that the UAV 200 is positioned in the first area 110 or the second area 190 when the second vision module detects that the UAV 200 is positioned in the first area 110 or the second area 190, or, determine that the UAV 200 is positioned in the first area 110 or the second area 190 in response to receiving the sending completion signal for indicating that the UAV 200 is positioned on the first area 110 from the base station 100. In some embodiments, the first area 110 or the second area 190 may include one or more of a positioning device, a first vision module, a gravity sensor, or a photoelectric sensor. The sending completion signal may be sent after one or more of the positioning device, first vision module, gravity sensor, or photoelectric sensor detecting that the UAV 200 is positioned on the first area 110.

In some embodiments, after the UAV 200 enters the automatic flight procedure, it may be further configured to send a takeoff signal to the base station 100.

In addition, an embodiment of the present disclosure further provides a computer-readable storage medium with a computer program stored thereon. When the computer program is executed by a processor, the processes of the base station control method or the UAV control method can be realized.

Since the apparatus embodiment basically corresponds to the method embodiment, for related information, reference may be made to the description in the method embodiment. The described apparatus embodiment is merely exemplary. The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments. A person of ordinary skill in the art may understand and implement the embodiments of the present invention without creative efforts.

Those skilled in the art shall understand that some or all steps in various methods described in the embodiments above may be accomplished by a program instructing relevant hardware to perform certain steps. The program can be stored in a computer-readable storage medium. The storage medium may include: a read only memory (ROM), a random access memory (RAM), a magnetic disk, or an optical disk, etc.

The above embodiments are only examples of the present disclosure, and do not limit the scope of the present disclosure. Although the technical solutions of the present disclosure are explained with reference to the above-described various embodiments, a person having ordinary skills in the art can understand that the various embodiments of the technical solutions may be modified, or some or all of the technical features of the various embodiments may be equivalently replaced. Such modifications or replacement do not render the spirit of the technical solutions falling out of the scope of the various embodiments of the technical solutions of the present disclosure.

What is claimed is:

1. A method for controlling a base station, comprising:
establishing a wireless communication with an unmanned aerial vehicle (UAV);
determining that the UAV has landed in a first area of the base station;
controlling a first power device of the base station to move in a first direction to control a guiding mechanism of the base station to move toward a transferring device of the base station to push the UAV onto the transferring device; and
controlling a second power device to move in a second direction to control a movement of the transferring device to transport the UAV to an operating platform.

2. The method of claim 1, wherein determining that the UAV has landed in the first area further comprises:
receiving a landing request sent by the UAV;
determining that the first area is unfolded, and determining that the first area allows the UAV to land; and
sending a landing permission signal to the UAV after determining that the first area is unfolded relative to the operating platform, and the first area allows the UAV to land.

3. The method of claim 2, wherein determining that the UAV has landed in the first area further comprises:
receiving a landing completion signal sent by the UAV; and,
determining that the UAV is positioned at the first area based on one or more of a positioning device, a vision module, a gravity sensor, or a photoelectric sensor, the first area including one or more of the positioning device, the vision module, the gravity sensor, or the photoelectric sensor.

4. The method of claim 1, wherein controlling the first power device to move in the first direction to control the guiding mechanism to move toward the transferring device to push the UAV onto the transferring device further comprises:
controlling the first power device to stop moving in response to determining that the UVA is positioned at the transferring device.

5. The method of claim 4, wherein determining that the UVA is positioned at the transferring device further comprises:
determining that the guiding mechanism moves toward the transferring device to a first position, the guiding mechanism including a first limit switch, when the guiding mechanism moves to the first position, the first limit switch output a first signal; and
determining that the guiding mechanism moves toward the transferring device to the first position comprises:
receiving the first signal from the first limit switch.

6. The method of claim 4, wherein after controlling the second power device to move toward the second direction to control the movement of the transferring device to transport the UAV to the operating platform, the method further comprises:
controlling the movement of the first power device toward a third direction for the guiding mechanism to move away from the transferring device, the third direction being opposite to the first direction;
controlling the first power device to stop moving in response to determining that the guiding mechanism moves away from the transferring device to a second position, the guiding mechanism including a second limit switch, when the guiding mechanism moves to the second position, the second limit switch output a second signal; and
determining that the guiding mechanism moves away from the transferring device to the second position further comprises:
receiving the second signal from the second limit switch.

7. The method of claim 1, wherein controlling the second power device to move toward the second direction to control the movement of the transferring device to transport the UAV to the operating platform further comprises:
controlling the second power device to stop moving in response to determining that the UAV is at the operating platform.

8. The device of claim 7, wherein:
a first photoelectric detection sensor is disposed at a first designated position of the operating platform, and determining the UAV is at the operating platform includes determining the first photoelectric detection sensor outputs a third signal, the first designated position being located on a side of the operating platform facing the first area.

9. The method of claim 7, wherein the base station further includes a second area, a transporting mechanism disposed in the second area, and a third power device for driving the transporting mechanism to move, the second area and the first area being respectively positioned on two sides of the operating platform, the operating platform being adjacent to one end of the transporting mechanism, and the method further comprises:
receiving a sending out request sent by the UAV;
determining a second photoelectric detection sensor outputs a fourth signal;
determining that the second area is unfolded relative to the operating platform, and determining that the second area allows the UAV to enter; and
controlling a movement of the third power device to control a movement of the transporting mechanism to transport the UAV from the operating platform to the second area.

10. The method of 1, wherein:
the base station is configured to perform data exchange with the UAV, the data exchange including obtaining data information of the UAV from the UAV, the data information of the UAV including one or more of image data information captured by an imaging device on the UAV, flight trajectory information of the UAV, historical position data information of the UAV, or power information of the UAV.

11. A base station comprising:
a processor; and
a memory storing program instructions that, when being executed by the processor, cause the processor to:
establish a wireless communication with a UAV;
determine the UAV has landed in a first area of the base station;
control a first power device of the base station to move in a first direction to control a guiding mechanism of the base station to move toward a transferring device push the UAV onto the transferring device; and
control a second power device to move in a second direction to control a movement of the transferring device to transport the UAV to an operating platform.

12. The base station of claim 11, wherein the processor is further configured to:
determine the UAV has landed in the first area in response to receiving a landing completion signal sent by the UAV; and,
determine the UAV has landed in the first area in response to one or more of a positioning device, a vision module, a gravity sensor, or a photoelectric sensor, detecting the UAV is positioned at the first area, the first area including the one or more of positioning device, the vision module, gravity sensor, or photoelectric sensor.

13. The base station of claim 11, wherein the processor is further configured to:
control the first power device to stop moving in response to determining that the UAV is positioned at the transferring device.

14. The base station of claim 11, wherein the processor is further configured to:
control the second power device to stop moving in response to determining that the UAV is at the operating platform.

15. A UAV control method comprising:
establishing a wireless communication with a base station;
detecting whether the UAV meets a first predetermined strategy, and if so, sending a landing request to the base station;
receiving a landing permission signal returned by the base station in response to the landing request; and
controlling the UAV to land in a first area of the base station to trigger the base station to perform an operation for transporting the UAV to an operating platform, wherein
the operating platform is configured to perform one or more operations of updating a power source of the UAV, replacing parts of the UAV, supplementing a payload of the UAV, or performing data exchange with the UAV.

16. The method of claim 15, wherein:
detecting whether the UAV meeting a first predetermined strategy comprises detecting the UAV meeting a condition for data exchange with the base station; and
detecting the UAV meeting the condition for data exchange with the base station comprises:
detecting a time between a current time and a time of a previous data exchange between the UAV and the base station meeting a predetermined period of time condition, or detecting data volume of data information of the UAV is greater than or equal to a predetermined data volume threshold, the data information of the UAV including one or more of image data information captured by an imaging device on the UAV, flight trajectory information of the UAV, or historical data information of the UAV.

17. The method of claim 15, wherein a vision module is disposed on the UAV, and the method further comprises:
detecting that the UAV is positioned at the first area based on the vision module; and
sending a landing completion signal to the base station to trigger the base station to perform the operation for transporting the UAV to the operating platform.

18. A UAV configured to cooperate with a base station comprising:
a processor; and
a memory storing program instructions that, when being executed by the processor, cause the processor to:
establish a wireless communication with the base station;
detect whether the UAV meets a first predetermined strategy, and if so, sending a landing request to the base station;
receive a landing permission signal returned by the base station in response to the landing request; and
control the UAV to land in a first area of the base station to trigger the base station to perform an operation for transporting the UAV to an operating platform.
